(19) United States
(12) Patent Application Publication
(10) Pub. No.: US 2007/0088617 A1
(43) Pub. Date: Apr. 19, 2007

(54) System of interactive real-person audio-visual on-line shop and method of the same

(76) Inventor: Cheng-Jen Yang, Jhongli City (TW)

Correspondence Address: THE MAXHAM FIRM, 9330 SCRANTON ROAD, SUITE 350, SAN DIEGO, CA, 92121, US

(21) Appl. No.: 11/251,712

(22) Filed: Oct. 17, 2005

(51) Int. Cl. G06Q 30/00

(52) U.S. Cl. 705/26

(57) ABSTRACT

The present invention provides a system of interactive real-person audio-visual on-line shop, which comprises a management module and at least one service module. Moreover, the system further comprises at least one service terminal for the agents to provide real time service. After the user logins into the system, her/he could click the button of the service module to transmit demand signal as her/he meets certain problems about the goods or the operation. Some agent would receive the demand signal and then provides instant exposition of the goods or the operation by means of VoIP (Voice over Internet Protocol), such as IP telephone.

### FIELD OF THE INVENTION

The present invention is related to an on-line shop method and system, especially, a method for an interactive real-person audio-visual on-line shop and the system of the same.

### BACKGROUND OF THE INVENTION

Recently, with the development of Internet, the on-line transaction is gradually accepted by the users. In any spot with Internet service, the user could shop in the on-line store without the limitation of the business hours. Such features of quickness and convenience would facilitate the growth of on-line shop. The user may purchase articles of daily use in various on-line shops. However, according to the experiences of most users, the current on-line shop system still has a few disadvantages. For example, the user could not clearly understand whether the goods could fulfill one's all needs due to the lack of interaction provided by the digital catalogs. In the situation that some questions are arisen, the user usually could not get instant help or information, and therefore be hesitant to proceed with on-line transaction.

Hence, it is certainly necessary to provide instant counseling service to help the users to understand the goods and eliminate the doubts while they are shopping on-line.

### SUMMARY OF THE INVENTION

The present invention provides a system and method of the interactive real-person on-line shop with the VoIP function. With the instant consultation provided by the service agent, the user may obtain proper information quickly. In addition, by collecting the questions about the goods, the seller could keep the reactions from the market and then carry out the improvement accordingly.

Another object of the present invention is providing a system and method of interactive real-person on-line shop with the VoIP function, especially the setting of peer-to-peer IP phone. Therefore, the management and setup of the service terminals and agents would become more flexible and the cost would be remarkably decreased.

Still another object of the present invention is providing a system and method of interactive real-person on-line shop with the VoIP function, especially the one-click function. Such one-click function would facilitate the instant communication between the user and the service agent. After the user logins the on-line shop, the linkage to the service agent would quickly made to perform the dialog, merely by clicking the button.

The interactive real-person on-line shop system according to the present invention comprises a management module and at least one service module. Such on-line shop system is built in the web server, and the user could login the on-line shop for on-line transaction. This interactive real-person on-line shop system may further comprise one or more service terminals for the service agents to provide instant on-line service. The management module manages the user authorization, transaction records, the user database and digital catalogs, such as such as profiles, digital images, functions and operation of the goods. Moreover, the service module also includes the VoIP module, namely the setting of peer-to-peer IP phone. The service module is coupled to the management module and the service terminals, respectively.

The service terminal is a computing device with VoIP function, and could be operated by at least one service agent. Such service terminal could include a camera, and in addition to provide instant exposition, the images or videos of the goods may also be captured and then transmitted to the user terminals immediately.

After the user logins the on-line shop, the button provided by the service module could be clicked as some questions about the goods or operation is raised during process of the on-line transaction. After that, at least one of the service terminals would receive the message by means of the VoIP module. Certain service agent then communicates with the user to provide instant exposition about the goods or related information. Additionally, the service agent could handle the transaction dispute and report the defect of the goods.

The method for providing interactive service of real-person on-line shop according to the present invention comprises steps of: providing a web interface for a user to login and browser goods by a user terminal, wherein the web interface includes a VoIP invoking interface; connecting the user terminal and a service terminal by utilizing the VoIP invoking interface by the user; and communicating a agent with the user by means of VoIP to conduct an on-line transaction.

### BRIEF DESCRIPTION OF THE DRAWINGS

FIG. 1 is the block diagram of the interactive real-person on-line shop system according to the preferred embodiment of the present invention.

FIG. 2 is the flow chart of the method for providing interactive service of real-person on-line shop according to the preferred embodiment of the present invention.

### DETAILED DESCRIPTION OF THE PREFERRED EMBODIMENT

The present invention is described with the preferred embodiments and accompanying drawings. It should be appreciated that all the embodiments are merely provided for illustration. Although the present invention has been described in terms of at least one preferred embodiments, the invention is not limited to these embodiments. The scope of the invention is defined by the claims. Modifications within the spirit of the invention will be apparent to those skilled in the art.

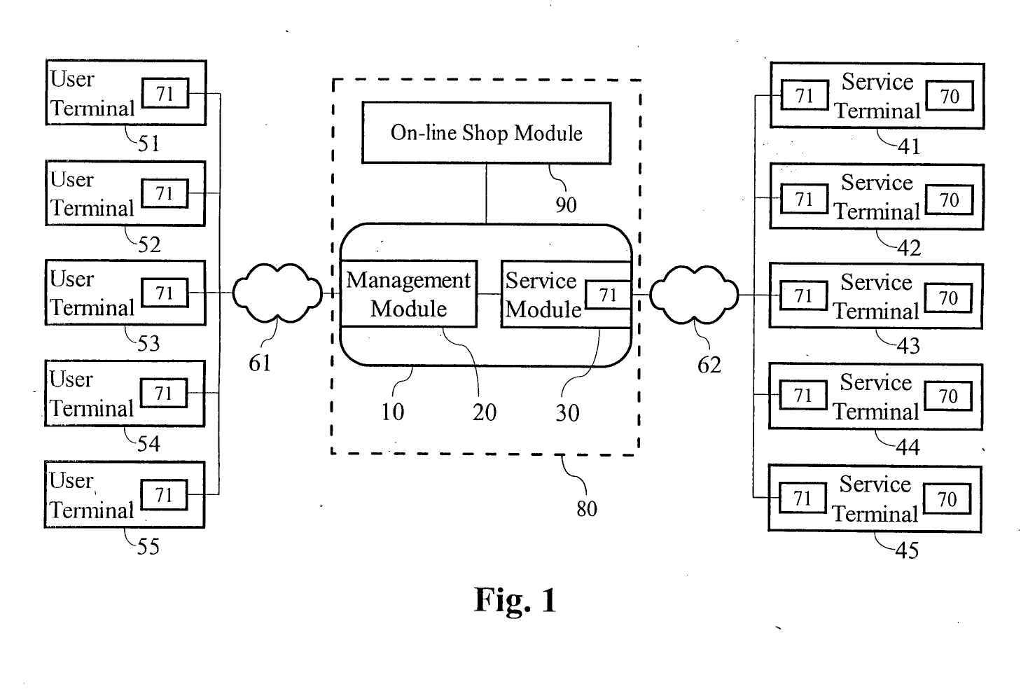

Please refer to FIG. 1, which illustrates the block diagram of the real-person audio-video on-line shop system according to one embodiment of the present invention. In the preferred embodiment, the on-line shop 10 comprises a management module 10 and at least one service module 30. The on-line shop 10 is built in a web server 80, and the on-line shop module 90 within the web server 80 may provide a shopping environment in web interface for a user to login the on-line shop 10. In this embodiment, the on-line shop 10 could further comprise service terminals 41-45.

The management module 20 may manage the user authorization, transaction records, the user database and digital catalogs, such as profiles, digital images, functions and operation of the goods. As the user browses the above mentioned web interface, the detail information of the goods would be provided to help the user to determine whether purchase certain items or not. After the transaction records are made, the user may logout the on-line shop 10.

The service module 30 further provides the VoIP function, especially peer-to-peer IP telephone. Such service module 30 is coupled to the management module 20 as well as the service terminals 41-45. Besides, the function sheet of the service module 30 may be provided in form of function buttons in the digital catalog of the on-line shop. The user could click one of them to trigger certain function. Plural kinds of language are supported by the service module 30, so the user may select suitable service terminal which could perform communication in desired language. Moreover, in one embodiment of the present invention, the VoIP modules 71 should be respectively installed or included in each user terminal, service terminal and service module for communication via network. Such VoIP modules 71 could be the software or the hardware installed in the user terminals and service terminals.

In the preferred embodiment of the present invention, the service terminals 41-45 could be a computing device with the VoIP function, such as the smart phone, the computer or the personal digital assistant (PDA). Besides, the service terminals 41-45 could be operated by one or more service agents. According to one embodiment of the present invention, the service terminals 41-45 could be set up in a concentrated service center. However, in another embodiment, the service terminals are widely distributed, and the agents are located in plural sites, even in one's home. Each service terminal may further include a camera 70, so in addition to provide vocal explanation through the VoIP phone, the service agent could also capture the goods or items and transmit the captured images or videos to the user.

After the user logins the management module 20 of the on-line shop 10 by one of the service terminals 51-55, the function sheet or the button provided by the service module 30 could be clicked as some questions about the goods or operation is raised during process of the on-line transaction. After that, at least one of the service terminals 41-45 would receive the message by means of the VoIP function. Certain service agent then communicates with the user to provide instant exposition about the goods or related information. Additionally, the service agent could handle the transaction dispute and report the defect of the goods.

In the preferred embodiment of the present invention, the user terminals 51-55 may be a computer, a smart phone, a personal digital assistant or any device capable of accessing the network. The user terminals 51-55 are coupled to the management module 20 through the network 61, and the service terminals 41-45 are coupled to the service module 30 through the network 62. The networks 61 and 62 include the LAN or the WAN, and they may couple to each other. In another embodiment of the present invention, the network 61 may be substantially the same as the network 62. For example, both networks are Internet.

Furthermore, it should be appreciated that merely five user terminals as well as five service terminals are presented in the preferred embodiment of the present invention, but the number of service and user terminals are not limited to five. In other embodiments of the present invention, the number of the service terminals may be modified according to the actual demand, and the number of the user terminals would depend on the capability of the web server 80. Besides, each user or service terminal could be operated by more than one user or service agent. Namely, two or more users or service agents may share one terminal.

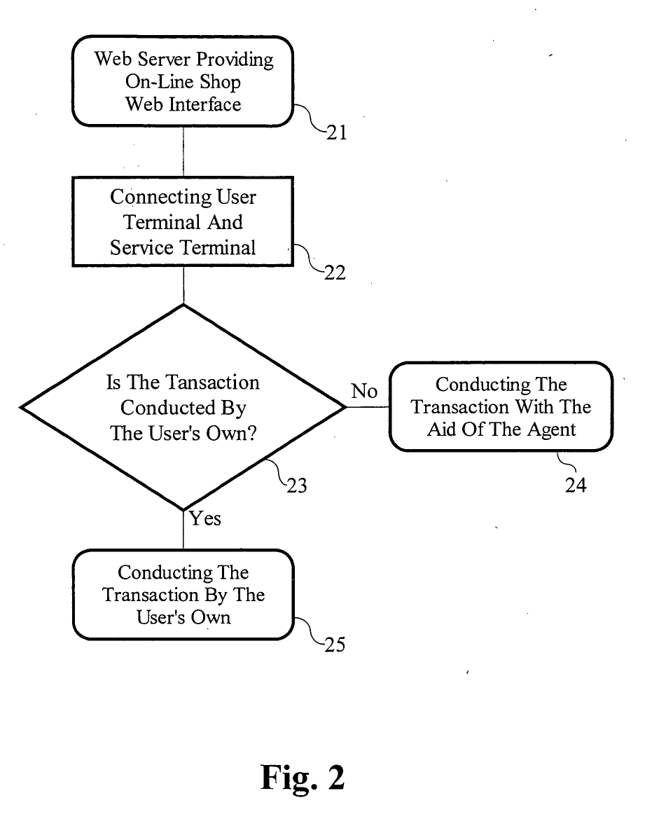

FIG. 2 presents a flow chart illustrating the service procedure of the on-line shop according to the preferred embodiment. First, in step 21, the on-line shop module 90 of the web server 80 provides a web interface for on-line shop, and the user may browsers this web interface by means of the user terminal (such as the smart phone, the personal digital assistant, the computer, etc.) with the ability of accessing Internet. Besides, the user may also the management module 20 of the on-line shop 10 via the web interface, and then proceed with on-line transaction. According to this embodiment, the portable device may be used as the user terminal to access Internet by means of IEEE 802.xx or WiFi, or the computer may be used to access Internet via the wired linkage. When certain problem is encountered during operation or transaction, the service button provided by the web interface could by clicked to invoke the VoIP function of the service module 30. As shown in step 22, the user terminal may therefore communicate with the service terminal by means of the invoked VoIP function. The user could tell the service agent about the demand or question directly, and the service agent would then provide instant service and information through the service terminal. At the same time, the user may determine whether or not make the order by oneself, as shown in step 23. If the user would like to make the order by oneself, in step 25, the user may conduct the transaction or modified the record by the management module 20, and then proceed with browsing the goods or leave the on-line shop. Otherwise, in step 24, the service agent could be instructed to conduct the transaction or modify the record for the user.

Furthermore, the user could choose the proper service agent with the ability of desired language. Besides providing instant response, the service agent may also capture the image of the goods by means of the camera of the service terminal. The captured images or the videos would then be transmitted to the user terminal to provide fuller understanding or information of the goods. The abovementioned IP telephone may adopt the VoIP standard, and the transmission of the images or videos is well-known technique. Moreover, the 3G mobile communication technology could also be adopt to transmit all data.

As is understood by a person skilled in the art, the foregoing preferred embodiments of the present invention are illustrated of the present invention rather than limiting of the present invention. It is intended to cover various modifications and similar arrangements included within the spirit and scope of the appended claims, and the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. An interactive real-person on-line shop system, wherein said system is built in a web server coupled to a network for providing service of on-line transaction, said system comprising:
a management module, for at least one user to login to conduct said on-line transaction; and
at least one service module, coupled to said management module and at least one service terminal respectively, wherein said service module includes VoIP (voice over Internet protocol) module, and said user communicates with said service terminal instantaneously through said service module by means of said VoIP module.

2. The system as set forth in claim 1, wherein said VoIP module includes a peer-to-peer IP telephone.

3. The system as set forth in claim 1, wherein said management module manages user authorization, transaction records, a user database and digital catalogs.

4. The system as set forth in claim 3, wherein said digital catalogs include at least one button for said user to click to invoke said VoIP module.

5. The system as set forth in claim 1, wherein said service module provides service items of plural languages.

6. An interactive real-person on-line shop system, for providing service of on-line transaction, said system comprises:
a management module, for at least one user to login to conduct said on-line transaction;
a service terminal, for one or more agents to communicate with said user by means of a VoIP module; and
at least one service module, coupled to said management module and said service terminal respectively, including said VoIP module, wherein said VoIP module is invoked by said user.

7. The system as set forth in claim 6, wherein said VoIP module includes a peer-to-peer IP telephone.

8. The system as set forth in claim 6, wherein said management module manages user authorization, transaction records, a user database and digital catalogs.

9. The system as set forth in claim 8, wherein said digital catalogs include at least one button for said user to click to invoke said VoIP module.

10. The system as set forth in claim 6, wherein said service terminal is set up in a concentrated service center.

11. The system as set forth in claim 6, wherein said service terminal is distributed, and said agents are located in plural sites.

12. The system as set forth in claim 6, wherein said service terminal provides service of plural languages.

13. The system as set forth in claim 6, wherein said service terminal includes a camera for said agents to capture images of goods, and said images are transferred to said user through network.

14. A method for providing interactive service of real-person on-line shop, which comprises:
providing a web interface for a user to login and browser goods by a user terminal, wherein said web interface includes a VoIP invoking interface;
connecting said user terminal and a service terminal by utilizing said VoIP invoking interface by said user; and
communicating a agent with said user by means of VoIP to conduct an on-line transaction.

15. The method as set forth in claim 14, wherein said on-line transaction is conducted through said web interface by said user.

16. The method as set forth in claim 14, wherein said on-line transaction is conducted with the aid of said agent.

17. The method as set forth in claim 14, wherein said VoIP invoking interface invokes a peer-to-peer IP telephone system.

18. The method as set forth in claim 14, wherein said service terminal is set up in a concentrated service center.

19. The method as set forth in claim 14, wherein said service terminal is distributed, and said agents are located in plural sites.

20. The method as set forth in claim 14, wherein said service terminal includes a camera for said agents to capture images of goods, and said images are transferred to said user through network.

21. The method as set forth in claim 14, wherein said service terminal includes a computer, a personal digital assistant (PDA), a smart phone or a computing device with the ability to access Internet.

22. The method as set forth in claim 14, wherein said VoIP invoking interface is a button or an item in said web interface.
